(19) United States
(12) Patent Application Publication
(10) Pub. No.: US 2008/0017162 A1
(43) Pub. Date: Jan. 24, 2008

(54) SURFACE TREATED COMPRESSION RING AND METHOD OF MANUFACTURE

(76) Inventor: Glenn E. Clever, Washington, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/459,436

(22) Filed: Jul. 24, 2006

(51) Int. Cl. F02F 3/00

(52) U.S. Cl. 123/193.6

(57) ABSTRACT

A piston ring is provided having a first axially facing surface and a second axially facing surface. At least one of the first and second axially facing surfaces has a friction reducing surface treatment. The friction reducing surface treatment is preferably formed from tungsten disulfide. Additionally, a method of forming a low friction piston ring is provided including applying a friction reducing surface treatment, such as tungsten disulfide, to at least one of the first and second axially facing surfaces and preventing the application of the friction reducing surface treatment on the radially outwardly facing surface. An internal combustion engine incorporating the disclosed piston ring is also provided.

### TECHNICAL FIELD

The present invention relates to a coated or surface treated compression ring for an internal combustion engine.

### BACKGROUND OF THE INVENTION

Internal combustion engines typically include at least one cylinder bore having a piston reciprocally movable therein. The piston and cylinder bore cooperate to at least partially define a combustion chamber. The piston may include at least one compression ring to seal the rapidly expanding combustion gases within a combustion chamber. The compression ring has been determined to be a source of friction within the internal combustion engine leading to a decrease in operating efficiency.

### SUMMARY OF THE INVENTION

A piston ring adapted to be received within a groove defined by a piston is provided. The piston ring includes a first axially facing surface and a second axially facing surface. A generally radially outwardly facing surface is also provided. At least one of the first and second axially facing surfaces has a friction reducing surface treatment, such as tungsten disulfide. The piston ring is further characterized by the lack of the friction reducing surface treatment on the generally radially outwardly facing surface. The piston ring may be either a first or second compression ring. The piston ring may be formed from steel or iron.

An internal combustion engine is also provided having a cylinder block defining a cylinder. A piston is reciprocally movable within the bore. The piston defines at least one generally annular ring groove. A piston ring is provided having a first axially facing surface and a second axially facing surface. The generally annular ring groove is sufficiently configured to receive at least a portion of the piston ring. At least a portion of the first and second axially facing surfaces has a friction reducing surface treatment, such as tungsten disulfide. The piston ring may be either a first or second compression ring. The piston ring may be formed from steel or iron. The piston ring has a generally radially outwardly facing surface in contact with the cylinder. The piston ring is further characterized by the lack of the friction reducing surface treatment on the generally radially outwardly facing surface.

A method of forming a low friction piston ring having first and second axially facing surfaces and a radially outwardly facing surface is also provided. The method includes applying a friction reducing surface treatment, such as tungsten disulfide, to at least one of the first and second axially facing surfaces. The method further includes substantially preventing the application of the friction reducing surface treatment from contacting the radially outwardly facing surface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross sectional view, partly in elevation, of a portion of an internal combustion engine including a piston having surface treated compression rings mounted thereto in accordance with the present invention; and

FIG. 2 is a magnified cross sectional view of a portion of the engine of FIG. 1, highlighted by a phantom circle, illustrating the compression rings and the surface treatment thereon.

### DESCRIPTION OF THE PREFERRED EMBODIMENTS

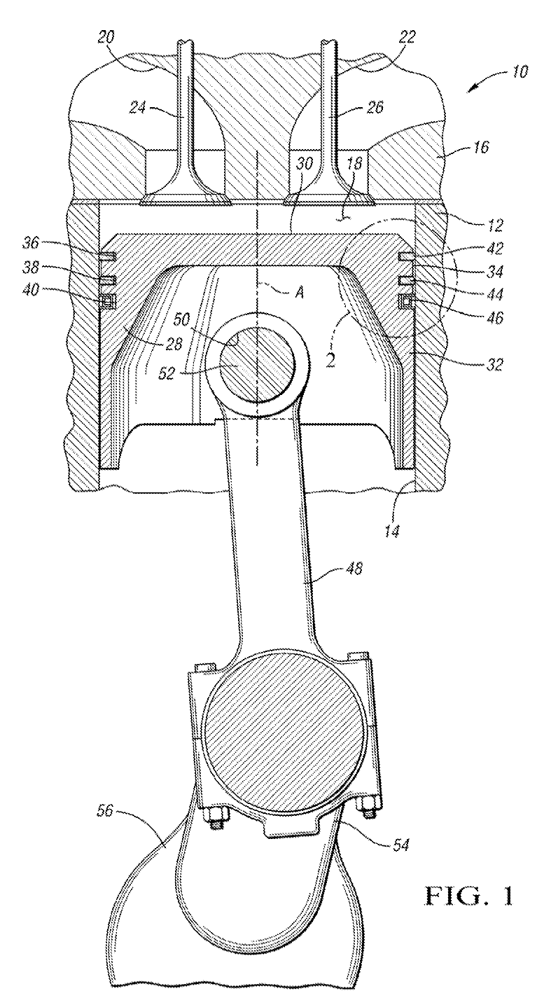

Referring to FIG. 1 of the drawings, there is shown an internal combustion engine generally indicated by numeral 10. The engine 10 includes a cylinder block 12 defining a cylinder 14. Although only one cylinder 14 is shown in FIG. 1, those skilled in the art will recognize that the present invention may be practiced on an engine having a plurality of cylinders 14. One end of the cylinder 14 is capped or closed by a cylinder head 16, which is mounted to the cylinder block 12. The cylinder 14 and cylinder head 16 cooperate to partially define a variable volume combustion chamber 18. The cylinder head 16 further defines an intake and exhaust port 20 and 22, respectively. Communication between the intake and exhaust ports 20 and 22 with the combustion chamber 18 is selectively controlled by poppet valves 24 and 26, respectively. The intake port 20 and popped valve 24 are operable to provide for the selective admission of air or air-fuel mixture to the combustion chamber 18, while the exhaust port 22 and poppet valve 26 are operable to provide for the selective exhaust of combustion products from the combustion chamber 18.

A piston 28 is reciprocally movable within the cylinder 14. The piston 28 is generally cylindrical about an axis A. The piston 28 includes a crown portion 30 having a generally cylindrical sidewall or skirt portion 32 depending or extending generally axially therefrom. A generally annular ring belt portion 34 is disposed between the skirt portion 32 and the crown portion 30.

The piston 28 is sufficiently configured for slidable reciprocating motion within the cylinder 14, the piston skirt portion 32 being engageable with the cylinder 14 to guide the piston 28 in its reciprocating motion and absorb side thrust forces. The outer diameter of the skirt portion 32 is formed somewhat smaller than the diameter of the cylinder 14 in order to provide a limited clearance to permit lubricating oil to remain on the cylinder 14 between the opposing surfaces for the reduction of friction and to provide for a generally free sliding motion of the piston 28 within the cylinder 14. The crown portion 30 cooperates with the cylinder 14 and the cylinder head 16 to further define the combustion chamber 18, which, upon movement of the piston 28, causes the expansion or contraction of the combustion chamber 18, as is required for operation on an engine working cycle.

The ring belt portion 34 defines a plurality of radially extending, axially spaced piston ring grooves which, in the present instance, consist of a generally annular first ring groove 36 extending closest to the crown portion 30, a generally annular second ring groove 38 spaced from the first ring groove 36 in an axial direction away from the crown portion 30. Similarly, a generally annular third ring groove 40 is spaced axially from the second ring groove 38, also in a direction away from the crown portion 30, and substantially adjacent the skirt portion 32.

The first ring groove 36 is sufficiently configured to receive a first compression ring 42, which is operable to engage the cylinder 14. The second ring groove 38 is sufficiently configured to receive a second compression ring 44, which is operable to engage the cylinder 14. The first and second compression rings 42 and 44 cooperate with the cylinder 14 to seal combustion gases within the combustion chamber 18 during engine operation. The third ring groove 40 is provided with an oil control ring 46, which operates to control the amount of lubrication oil at the interface between the piston 28 and the cylinder 14. Additionally, the first and second compression rings 42 and 44 may be formed from steel or iron.

In order to utilize the piston 28 as a means for developing power, the piston 28 and a connecting rod 48 each at least partially define an opening or bore 50 sufficiently configured to receive a piston pin 52. The piston pin 52 mechanically interconnects the piston 28, through the connecting rod 48, with an eccentric throw 54 of a crankshaft 56. Reciprocation of the piston 28 within the cylinder 14 effects the rotation of the crankshaft 56. The angular position of the connecting rod 48 varies as the crankshaft 56 rotates so that forces acting on the piston 28 in an axial direction are resolved partially into a side thrust component that alternately acts in opposite directions transversely on the piston 28, causing thrust forces between the piston skirt portion 32 and the cylinder 14. These thrust forces act in the plane of movement of the engine connecting rod 48 and thus are concentrated at two opposite sides of the piston 28 and are reacted primarily by the skirt portion 32 at points laterally opposite the piston pin 52.

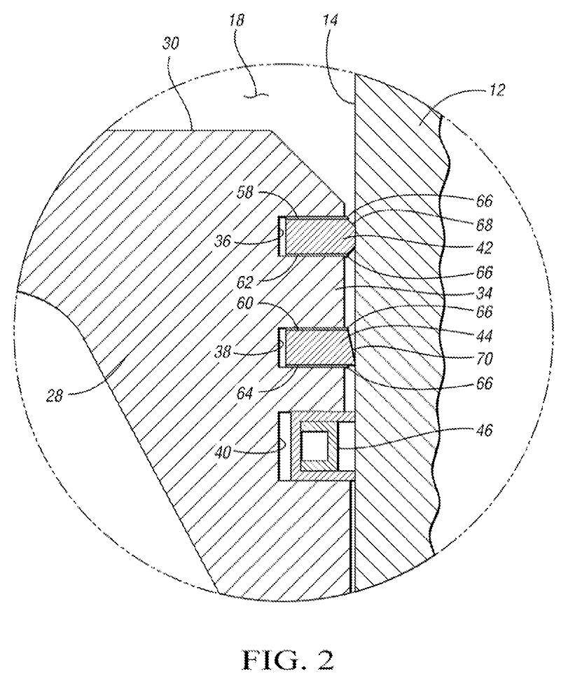

Referring now to FIG. 2 there is shown a magnified view of the portion of the engine 10 highlighted with a phantom circle 2 in FIG. 1. Each of the first and second compression rings 42 and 44 have a respective first axial surface 58 and 60 and a respective opposite second axial surface 62 and 64. It has been determined through experimental testing with a single cylinder engine having a floating cylinder liner that the engagement of the first and second axial surfaces 58, 60 and 62, 64 of the respective first and second compression rings 42 and 44 with the piston 28 may contribute to the overall friction of the engine 10.

The present invention provides a friction reducing layer or surface treatment 66, preferably in the form of tungsten disulfide in lamellar form on at least one of the first and second axial surfaces 58, 60 and 62, 64 of at least one of the first and second compression rings 42 and 44. Preferably, the friction reducing surface treatment 66 sill span substantially the entirety of the axial surface 58, 60, 62, and/or 64 to which it is applied. By providing the friction reducing surface treatment 66, the friction between the first and/or second compression rings 42, 44 and the piston 28 and cylinder bore 14 may be reduced. Additionally, the onset of micro-welding between the first compression ring 42 and the piston 28 may be delayed or eliminated, thereby eliminating the need to anodize or otherwise treat the first ring groove 36. The first and second compression rings 42 and 44 of the present invention are further characterized as being devoid of the friction reducing surface treatment 66 on the radially outwardly facing surfaces 68 and 70, respectively. The surfaces 68 and 70 are at least partially in contact with the cylinder 14 and as such, by not providing a friction reducing surface treatment 66 on these surfaces 68 and 70, the effect of the friction reducing surface treatment 66 on the engine run-in performance is not a concern. Additionally, the friction reducing surface treatment 66 is typically less than one micron or one thousandth of a millimeter thick. Therefore the friction reducing surface treatment 66 may be applied to the first and/or second compression rings 42 and 44 with little concern for tolerance changes between the first and second compression rings 42 and 44 and the respective first and second ring grooves 36 and 38.

The friction reducing surface treatment 66 of tungsten disulfide may be applied by burnishing or high velocity spray impingement. Since the friction reducing surface treatment 66 is typically applied at ambient temperatures, the metallurgical properties of the first and/or second compression rings 42 and 44 will remain substantially unchanged. Additionally, the surface treatment adheres to the first and/or second compression ring 42, 44 through a molecular mechanical interlock thereby reducing the chance that the friction reducing surface treatment 66 will flake, blister, chip, or peel.

While the best modes for carrying out the invention have been described in detail, those familiar with the art to which this invention relates will recognize various alternative designs and embodiments for practicing the invention within the scope of the appended claims.

1. A piston ring adapted to be received within a groove defined by a piston, the piston ring comprising:
a first axially facing surface;
a second axially facing surface;
a generally radially outwardly facing surface;
wherein at least one of said first and second axially facing surfaces has a friction reducing surface treatment provided thereon; and
wherein said piston ring is further characterized by the lack of said friction reducing surface treatment on said generally radially outwardly facing surface.

2. The piston ring of claim 1, wherein the friction reducing surface treatment is formed from tungsten disulfide.

3. The piston ring of claim 1, wherein said piston ring is a first compression ring.

4. The piston ring of claim 1, wherein said piston ring is a second compression ring.

5. The piston assembly of claim 1, wherein said piston ring is formed from iron.

6. The piston ring of claim 1, wherein said piston ring is formed from steel.

7. An internal combustion engine comprising:
a cylinder block defining a cylinder bore;
a piston reciprocally movable within said cylinder bore;
wherein said piston defines at least one generally annular ring groove;
a piston ring having a first axially facing surface and a second axially facing surface;
wherein said at least one generally annular ring groove is sufficiently configured to receive at least a portion of said piston ring; and
wherein at least one of said first and second axially facing surfaces has a friction reducing surface treatment provided thereon.

7. The internal combustion engine of claim 6, wherein said friction reducing surface treatment is formed from tungsten disulfide.

8. The internal combustion engine of claim 6, wherein said piston ring is a first compression ring.

9. The internal combustion engine of claim 6, wherein said piston ring is a second compression ring.

10. The internal combustion engine of claim 6, wherein said piston ring is formed from iron.

11. The internal combustion engine of claim 6, wherein said piston ring is formed from steel.

12. The internal combustion engine of claim 6, wherein said piston ring has a generally radially outwardly facing surface in contact with said cylinder and wherein said piston ring is further characterized by the lack of said friction reducing surface treatment on said generally radially outwardly facing surface.

13. A method of forming a low friction piston ring having first and second axially facing surfaces and a radially outwardly facing surface, the method comprising:
applying a friction reducing surface treatment to at least one of the first and second axially facing surfaces; and
substantially preventing the application of said friction reducing surface treatment from contacting the radially outwardly facing surface.

13. The method of claim 12, wherein said friction reducing surface treatment is applied by burnishing.

14. The method of claim 12, wherein said friction reducing surface treatment is applied by spray impingement.

15. The method of claim 12, wherein the piston ring is formed from one of steel and iron.

16. The method of claim 12, wherein said friction reducing surface treatment is formed from tungsten disulfide.
